(19) United States
(12) Patent Application Publication
(10) Pub. No.: US 2014/0293868 A1
(43) Pub. Date: Oct. 2, 2014

(54) METHOD AND APPARATUS FOR PROVIDING FEEDBACK

(71) Applicant: Broadcom Corporation, Irvine, CA (US)

(72) Inventors: Toni Levanen, Tampere (FI); Timo Kalevi Koskela, Oulu (FI); Anna Pantelidou, Oulu (FI); Juho Mikko Oskari Pirskanen, Kangasala (FI)

(73) Assignee: Broadcom Corporation, Irvine, CA (US)

(21) Appl. No.: 13/851,353

(22) Filed: Mar. 27, 2013

(51) Int. Cl. H04L 1/08

(52) U.S. Cl. CPC H04L 1/08
USPC 370/328

(57) ABSTRACT

A method, apparatus and computer program for providing a frame based access (FBA). An example method for use in an access point or station may comprise causing capture of a header, for example PLCP or PHY header from an attempted packet transfer and causing transmission of a negative acknowledgement (NACK) frame in response to a transmitter comprising the decoded address in the header, the NACK configured to indicate a failure to receive or decode data from the attempted packet transfer.

### TECHNOLOGICAL FIELD

An example embodiment of the present invention relates generally to wireless communications technology and, more particularly, to a method, apparatus and computer program product for providing a negative acknowledgment frame.

### BACKGROUND

Current wireless land area network (WLAN) (e.g., 802.11) systems do not support transmitting negative acknowledgement (NACK) frames. If a transmitted packet is detected, an ACK is transmitted by the receiver. If transmitted packet is not detected, the receiver does not transmit anything. Instead, the transmitting node may invoke a back-off algorithm and retransmit its packet after a random back-off period. This operation may occur because in 802.11 networks, the Modulation and Coding Scheme (MCS) may be conservatively chosen to meet the link quality. Thus, when a transmitted packet fails, it may be assumed that failure is the result of a collision. However, a more aggressive adaptive modulation may have gains in some cases by allowing a packet to be transmitted faster at a higher rate. However, when a more aggressive modulation is used, a packet may fail not only because of a packet collision but also because of a wrong MCS choice. In this case, assuming that the transmitter address is captured, a NACK may avoid unnecessary increases in the delay caused by the random contention process and provide fast retransmission by transmitting a packet after a certain fixed margin. A NACK may further provide a mechanism that allows the retransmissions not to be independent of the original transmissions. Additionally, a Hybrid Automatic Repeat request (HARM) scheme may be supported, in which the retransmission may be initiated faster and both the transmitter and the receiver may know how the retransmitted packets are related to the initial transmission.

### BRIEF SUMMARY

This invention relates to wireless land area network (WLAN) (e.g., 802.11) system family and proposes two new NACK frame designs. A first NACK frame design may be related to existing ACK frame and a second NACK frame design may be a new frame type.

In one example embodiment of the present invention, a method is provided for use in an access point or station comprising causing capture of a header from an attempted packet transfer, and causing transmission of a negative acknowledgement (NACK) frame in response to a transmitter comprising the decoded address in the header, the NACK configured to indicate a failure to receive or decode data from the attempted packet transfer. In one embodiment, the NACK frame is at least one of an amended acknowledgment (ACK) frame, a new NACK frame, a NACK appended to data.

In one embodiment, in an instance in which the header includes a transmitter address, an amended ACK frame is formed by modifying a first field, which comprises a Group ID field and a Partial association identifier (AID) field, by setting the Partial AID field to a value calculated from a Group ID field of the captured header and its own Basic Service Set IDentifier (BSSID). In another embodiment, in an instance in which the header includes a transmitter address, an amended ACK frame is formed by modifying a first field, which comprises a Group ID field and a Partial AID field, by setting the Partial AID field to a value of the partial AID of the captured header and setting the Group ID field to its own partial ID. In another embodiment, in an instance in which the header includes a transmitter address, a new NACK frame is formed by moving MAC layer information to a PHY layer and causing formation of a SIG filed comprising information from a frame control field, a duration field, a receiver address (RA) field and a frame check sequence (FCS) field of an ACK frame.

In one embodiment, in an instance in which the header does not include a transmitter address, an amended ACK frame is formed by utilizing a specific combination of frame control bits and modifying an existing ACK frame by replacing a receiver address (RA) field with a transmitter address of a transmitting device. In one embodiment, the header is a Physical Layer Convergence Protocol (PLCP) header.

In another example of the present invention, a method is provided for use in an access point or station comprising providing an attempted packet transfer, wherein the packet comprises a header portion and a data portion and providing retransmission of previously sent data portion in a same or modified format after receiving a negative acknowledgement (NACK) frame in response to the attempted packet transfer, the NACK configured to indicate a failure to receive or decode data from the attempted packet transfer. In one embodiment, wherein retransmission of previously sent data portion is provided in a modified format; and wherein the method further comprises providing explicit or implicit signaling of one or more modifications.

In another example of the present invention, an apparatus is provided. The apparatus may comprise at least one processor and at least one memory including computer program code, the at least one memory and the computer program code configured to, with the processor, cause the apparatus to at least cause capture of a header from an attempted packet transfer and cause transmission of a negative acknowledgement (NACK) frame in response to a transmitter comprising the decoded address in the header, the NACK configured to indicate a failure to receive or decode data from the attempted packet transfer. In one embodiment, the NACK frame is at least one of an amended acknowledgment (ACK) frame, a new NACK frame, a NACK appended to data.

In one embodiment, in an instance in which the header includes a transmitter address, an amended ACK frame is formed by modifying a first field, which comprises a Group ID field and a Partial AID field, by setting the Partial AID field to a value calculated from a Group ID field of the captured header and its own BSSID. In another embodiment, in an instance in which the header includes a transmitter address, an amended ACK frame is formed by modifying a first field, which comprises a Group ID field and a Partial AID field, by setting the Partial AID field to a value of the partial AID of the captured header and setting the Group ID field to its own partial ID. In another embodiment, in an instance in which the header includes a transmitter address, a new NACK frame is formed by moving MAC layer information to a PHY layer and causing formation of a SIG filed comprising information from a frame control field, a duration field, a receiver address (RA) field and a frame check sequence (FCS) field of an ACK frame.

In one embodiment, in an instance in which the header does not include a transmitter address, an amended ACK frame is formed by utilizing a specific combination of frame control bits and modifying an existing ACK frame by replacing a receiver address (RA) field with a transmitter address of a transmitting device. In one embodiment, the header is a Physical Layer Convergence Protocol (PLCP) header.

In another example embodiment of the present invention, an apparatus is provided. The apparatus may comprise at least one processor and at least one memory including computer program code, the at least one memory and the computer program code configured to, with the processor, cause the apparatus to at least provide an attempted packet transfer, wherein the packet comprises a header portion and a data portion and provide retransmission of previously sent data portion in a same or modified format after receiving a negative acknowledgement (NACK) frame in response to the attempted packet transfer, the NACK configured to indicate a failure to receive or decode data from the attempted packet transfer. In one embodiment, wherein retransmission of previously sent data portion is provided in a modified format; and wherein the at least one memory and the computer program code are further configured to, with the processor, cause the apparatus to provide explicit or implicit signaling of one or more modifications.

In one example embodiment of the present invention, a computer program product may be provided. The computer program product may comprise at least one non-transitory computer-readable storage medium having computer-executable program code portions stored therein, the computer-executable program code portions comprising program code instructions for causing capture of a header from an attempted packet transfer and causing transmission of a negative acknowledgement (NACK) frame in response to a transmitter comprising the decoded address in the header, the NACK configured to indicate a failure to receive or decode data from the attempted packet transfer. In one embodiment, the NACK frame is at least one of an amended acknowledgment (ACK) frame, a new NACK frame, a NACK appended to data.

In one embodiment, in an instance in which the header includes a transmitter address, an amended ACK frame is formed by modifying a first field, which comprises a Group ID field and a Partial AID field, by setting the Partial AID field to a value calculated from a Group ID field of the captured header and its own BSSID. In another embodiment, in an instance in which the header includes a transmitter address, an amended ACK frame is formed by modifying a first field, which comprises a Group ID field and a Partial AID field, by setting the Partial AID field to a value of the partial AID of the captured header and setting the Group ID field to its own partial ID. In another embodiment, in an instance in which the header includes a transmitter address, a new NACK frame is formed by moving MAC layer information to a PHY layer and causing formation of a SIG filed comprising information from a frame control field, a duration field, a receiver address (RA) field and a frame check sequence (FCS) field of an ACK frame.

In one embodiment, in an instance in which the header does not include a transmitter address, an amended ACK frame is formed by utilizing a specific combination of frame control bits and modifying an existing ACK frame by replacing a receiver address (RA) field with a transmitter address of a transmitting device. In one embodiment, the header is a Physical Layer Convergence Protocol (PLCP) header.

In another example embodiment of the present invention, a computer program product may be provided comprising at least one non-transitory computer-readable storage medium having computer-executable program code portions stored therein, the computer-executable program code portions comprising program code instructions for providing an attempted packet transfer, wherein the packet comprises a header portion and a data portion and providing retransmission of previously sent data portion in a same or modified format after receiving a negative acknowledgement (NACK) frame in response to the attempted packet transfer, the NACK configured to indicate a failure to receive or decode data from the attempted packet transfer. In one embodiment, wherein retransmission of previously sent data portion is provided in a modified format; and wherein the method further comprises providing explicit or implicit signaling of one or more modifications.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a schematic representation of a system that supports communications between access points and stations in accordance with an example embodiment of the present invention;

FIG. 2 is a block diagram of an apparatus that may be embodied by an access point or a station and that may be specifically configured in accordance with an example embodiment of the present invention;

FIG. 3 is a flow chart illustrating operations performed, such as by the apparatus of FIG. 2 embodied by an access point, in accordance with an example embodiment of the present invention;

FIG. 4 is a flow chart illustrating operations performed, such as by the apparatus of FIG. 2 embodied by an access point, in accordance with another example embodiment of the present invention

FIG. 5 shows an example illustration of a SIG A1 field in accordance with an example embodiment of the present invention;

FIG. 6A shows an example illustration of a NACK frame based on an ACK frame that supports HARQ in accordance with an example embodiment of the present invention;

FIG. 6B shows an example illustration of a HARQ Information Element in accordance with an example embodiment of the present invention;

FIG. 7A an example illustration of a new NACK frame that supports HARQ in accordance with an example embodiment of the present invention;

FIG. 7B shows an example illustration of an exemplary structure of a new short NACK frame format based on short ACK frame in accordance with an example embodiment of the present invention;

FIG. 8A shows an example illustration of a current ACK MAC layer packet in accordance with an example embodiment of the present invention;

FIG. 8B shows an example illustration of an implementation of a NACK frame with a TA address in accordance with an example embodiment of the present invention; and

FIG. 9 is a flow chart illustrating operations performed, such as by the apparatus of FIG. 2 embodied by a station, in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product are provided in accordance with an example embodiment of the present invention in order to provide feedback. As such, the method, apparatus and computer program product of an example embodiment may provide feedback in response to a failure to receive or decode data from the attempted packet transfer.

A number of modes of operation may be supported by the method, apparatus, and computer program products, such as for example Distributed coordination function (DCF), Transmission Opportunity (TXOP), and Random Access Window (RAW). DCF includes a positive acknowledge scheme, which means that if a frame is successfully received by the destination it is addressed to, the destination needs to send an ACK frame to notify the source of the successful reception. DCF, however, does not distinguish between a packet failure due to a collision or due to an error. Thus, if a packet is not received by a receiver nothing is sent. The transmitter will try retransmitting the packet at some time in the future. No NACK is sent. This makes transmissions and retransmissions completely independent in 802.11. DCF requires a station wishing to transmit to listen for the channel status for a DIFS interval. If the channel is found busy during the DIFS interval, the station defers its transmission. As a result of multiple STAs contending for a channel, collisions may occur. In order to avoid such collisions, DCF also specifies random backoff, which forces a station to defer its access to the channel for an extra period.

A different mode of operation is TXOP operation. Under this mode a transmitting node can send a packet to a receiving node without the need to contend for the channel. The AP or STA that has gained the TXOP is called the TXOP holder and it sends frames to another STA or an AP which will be the TXOP responder. During a TXOP multiple frames can be transmitted one after the other, spaced by the Short Interframe Space (SIFS) duration. In this invention TXOP operation is considered in the following cases: a) The hybrid coordination function (HCF) Enhanced Distributed Channel Access (EDCA) and Control Channel Access (HCCA) in a BSS, b) HCF EDCA TXOPs in IBSS networks, and c) TXOP operation in MESH network.

In HCF, the Hybrid Coordinator controls the bandwidth by allocating multiple transmission opportunities to the STAs. TXOPs are obtained either by the Hybrid Coordinator in HCCA or by regular channel contention in EDCA. During a mesh peer service period a mesh STA may obtain multiple TXOPs in a single direction. Even though the above examples of TXOP operation are mentioned, this invention applies in general in network operation modes where the channel is reserved for multiple transmissions that are spaced apart by a given duration.

In HCF, a STA requests the HC for TXOPs, both for its own transmission as well as for the transmissions of the AP. The request may be accepted or rejected by the HC. If the TXOP is accepted the HC will schedule transmissions both for the AP and the non-AP STA. The AP can obtain the TXOP directly from its collocated HC for its own transmissions. To request a TXOP a STA uses the QoS control field in a QoS data frame or in a QoS Null frame. This field may indicate the duration for which the TXOP (TXOP Duration Requested subfield) is requested or the Queue Size subfield along with a Traffic Identifier (TID). Whether an AP can process a TXOP or not is indicated in a Beacon, (Re)Association Response frame or in a Probe Response frame. In HCCA the HC may command the AP to poll a TXOP by sending a QoS+CF-Poll frame to the STA. This type of TXOP is called a polled TXOP.

For the transmissions from the STAs, the AP polls the STAs based on the parameters chosen by the STA during initiation of the TXOP.

The number of transmissions inside a TXOP is restricted by the TXOP limit. It specifies the duration for which the TXOP will be granted. This field has 8 bits in QoS data frames, each of which has a unit of 32 μs. The durations that can be obtained inside a TXOP range between 32 μs and 8160 μs, with increments of 32 μs. A TXOP limit value equal to 0 means that a single MPDU or a QoS Null frame will be transmitted during the TXOP. The AP may use the QoS queue size information field of the STA for a given access class to obtain the size of the TXOP that it will give to the STA for frames of this particular access category (AC). The actual duration of the TXOP is given by the TXOP Duration Requested subfield that is sent by a STA to indicate the amount of time it estimates it needs for its next TXOP.

The TXOP Duration Requested subfield is present in QoS data frames sent by STAs associated in a BSS with bit 4 of the QoS Control field equal to 0. The TXOP Duration Requested subfield is an 8-bit field that indicates the duration, in units of 32 μs, that the sending STA determines it needs for its next TXOP for the specified TID. A value of 0 indicates that no TXOP is requested for the specified TID in the current SP. A nonzero value represents a duration in the range of 32 μs to 8160 μs in increments of 32 μs.

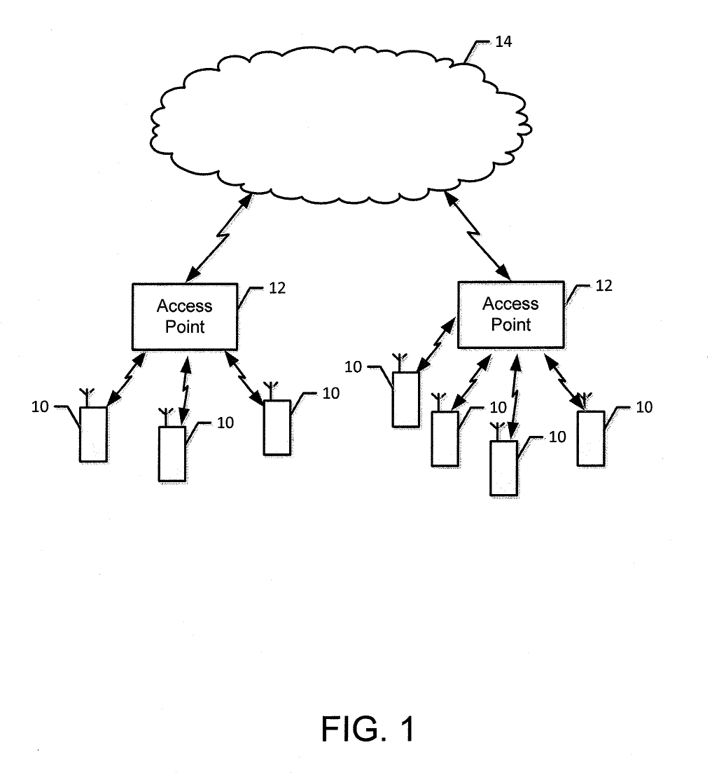

Referring now to FIG. 1, which illustrates an example system that supports communications between a plurality of stations 10 and one or more access points 12, each access point may communicate with one or more stations and, in one embodiment, may communicate with a large number of stations, such as 6,000 or more stations. The access points may, in turn, communicate with a network 14. While the access points may communicate via an Long Term Evolution (LTE) or LTE-Advanced (LTE-A) network, other networks may support communications between the access points including those configured in accordance with wideband code division multiple access (W-CDMA), CDMA2000, global system for mobile communications (GSM), general packet radio service (GPRS), the IEEE 802.11 standard including, for example, the IEEE 802.11ah or 802.11 ac standard or other newer amendments of the standard, wireless local access network (WLAN), Worldwide Interoperability for Microwave Access (WiMAX) protocols, universal mobile telecommunications systems (UMTS) terrestrial radio access network (UTRAN) and/or the like.

The access points 12 and the stations 10 may communicate via wireline communications, but most commonly communicate via wireless communications. For example, the access points and the stations may communicate in a sub 1 GHz band as defined by IEEE 802.11ah standard or in a 5 GHz band, which may be defined by, for example, IEEE 802.11ac standard. The access point may be embodied by any of a variety of network entities, such as an access point, a base station, a Node B, an evolved Node B (eNB), a radio network controller (RNC), a mobile device (e.g., mobile telephones, smart phones, portable digital assistants (PDAs), pagers, laptop computers, tablet computers or any of numerous other hand held or portable communication devices, computation devices, content generation devices, content consumption devices, or combinations thereof), or the like. The stations may also be embodied by a variety of devices, such as sensors, meters or the like. The sensors and meters may be deployed in a variety of different applications including in utility applications to serve as a gas meter, a water meter, a power meter or the like, in environmental and/or agricultural monitoring applications, in industrial process automation applications, in healthcare and fitness applications, in building automation and control applications and/or in temperature sensing applications. Stations that are embodied by sensors or meters may be utilized in some embodiments to backhaul sensor and meter data. Alternatively, the stations may be embodied by mobile terminals or user equipment(s) (UE), such as mobile communication devices, e.g., mobile telephones, smart phones, portable digital assistants (PDAs), pagers, laptop computers, tablet computers or any of numerous other hand held or portable communication devices, computation devices, content generation devices, content consumption devices, or combinations thereof. In an embodiment in which the station is embodied by a mobile terminal, the communication between an access point and the station may serve to extend the range of wi-fi or another wireless local area network (WLAN), such as by extending the range of a hotspot, and to offload traffic that otherwise would be carried by a cellular or other network.

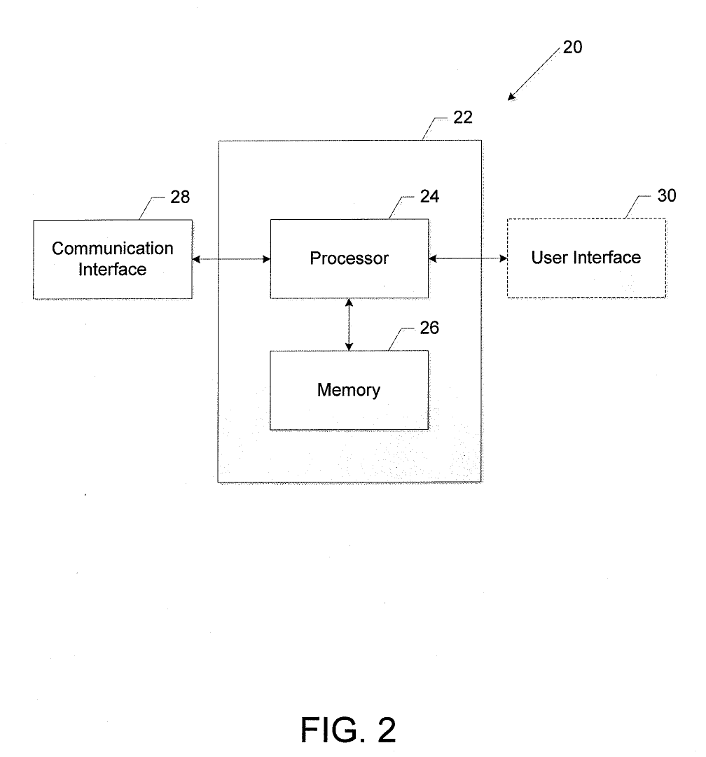

The access point 12 and/or the station 10 may be embodied as or otherwise include an apparatus 20 that is specifically configured to perform the functions of the respective device, as generically represented by the block diagram of FIG. 2. While the apparatus may be employed, for example, by an access point or a station, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution, signal processing, measurements and report generation, and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein. Alternatively or additionally, a processing system may be embodied by or have similar functionality to the processing circuitry.

In an example embodiment, the processing circuitry 22 may include a processor 24 and memory 26 that may be in communication with or otherwise control a communication interface 28 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments, the processing circuitry may be embodied as a portion of the mobile terminal 10.

The user interface 30 (if implemented) may be in communication with the processing circuitry 22 to receive an indication of a user input at the user interface and/or to provide an audible, visual, mechanical or other output to the user. In this regard, the user interface and/or the processing circuitry 22 may include user interface circuitry configured to facilitate user control of at least some functions based upon user input. The user interface may include, for example, a keyboard, a mouse, a trackball, a display, a touch screen, a microphone, a speaker, and/or other input/output mechanisms. The apparatus 20 need not always include a user interface.

The communication interface 28 may include one or more interface mechanisms for enabling communication with other devices and/or networks, such as for enabling communication between an access point 12 and a station 10 or between two or more stations. In some cases, the communication interface may be any means such as a device or circuitry embodied in either hardware, or a combination of hardware and software that is configured to receive and/or transmit data from/to a network and/or any other device or module in communication with the processing circuitry 22. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory may be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an application specific integrated circuit (ASIC), an field programmable gate array (FPGA), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

A method, apparatus and computer program product are provided in accordance with an example embodiment of the present invention in order to provide feedback in response to a failure to receive or decode data from the attempted packet transfer.

As such, the method, apparatus and computer program product of an example embodiment may provide feedback by causing transmission of a negative acknowledgement (NACK) frame in response to a failure to receive or decode data from the attempted packet transfer. Transmitting a NACK when a packet header is captured but the data is not received may help to distinguish an instance when collisions occur. For example, when a NACK or ACK are not sent, a transmitter may adapt more efficiently its back off window and other back off or EDCA parameters to combat congestion and hidden terminals more efficiently. Thus, a NACK may avoid increases in a delay caused by the random contention process and provide fast retransmission by transmitting a packet after a certain fixed margin.

This can further provide a mechanism that allows the retransmissions to be related to the original transmissions and further support HARQ schemes, in which the retransmission may be initiated faster and both the transmitter and the receiver may know how the retransmitted packets are related to the initial transmission. Such a mechanism enables diversity and combining gain for the retransmissions.

HARQ has been used in cellular systems when the transmission is contention free meaning that each transmitter and receiver pair has dedicated resources to be used for transmission. There are two well-known HARQ principles called cache-combining and incremental redundancy used in cellular systems. In chase combining each transmitter packet is self-decodable and the receiver can sum the signal energy of each transmission. In incremental redundancy the re-transmission contains additional redundancy information to improve FEC and channel coding results.

The basic benefit of HARQ is that link adaptation can be employed more aggressively since the effect of packet transmission failure is smaller and combination of separate transmissions is possible. A typical operation point of link adaptation with HARQ is 10% of BLER where 90% of transmissions go through with a selected MCS setting and the remaining 10% is recovered with few re-transmissions.

So far HARQ has not been used in random access in existing wireless standards such as 802.11. In 802.11 this is due to several reasons. First the transmitter ID is part of the MAC header. So, a receiver can know the transmitter identity only after it has correctly decoded the original packet. In case the packet is unsuccessful, the packet transmitter identity is not known and no ACK or other response is sent by the receiver. If the transmitter of the original packet receives no ACK after SIFS time it assumes that the transmission failed. In fact, in 802.11 the assumption is that the transmission failed, most likely, due to a collision, and the transmitter of the packet initiates its collision avoidance procedure by doubling its transmission back-off window. The transmitter will retransmit the packet when it observes the medium to be idle for DIFS time and after its back-off timer expires. Thus, synchronization between a transmission and its retransmission is completely lost. This leads to a situation where each transmission (original and all re-transmissions) are totally independent and the receiver cannot utilize information received in the previous transmission to decode packet correctly in re-transmission. Even if a receiver knew the transmitter identity, the receiver may not have any way to know when the original packet will be retransmitted and may have to store the partially received packet in its buffer for a potentially large amount of time. However, depending on the receiver capability, it may be able store multiple partially received copies (from different stations) to be combined with the retransmissions. In one example AP may use scheduling to allocate UL transmission opportunities for the STAs it has knowledge may need to retransmit and at which time they may retransmit.

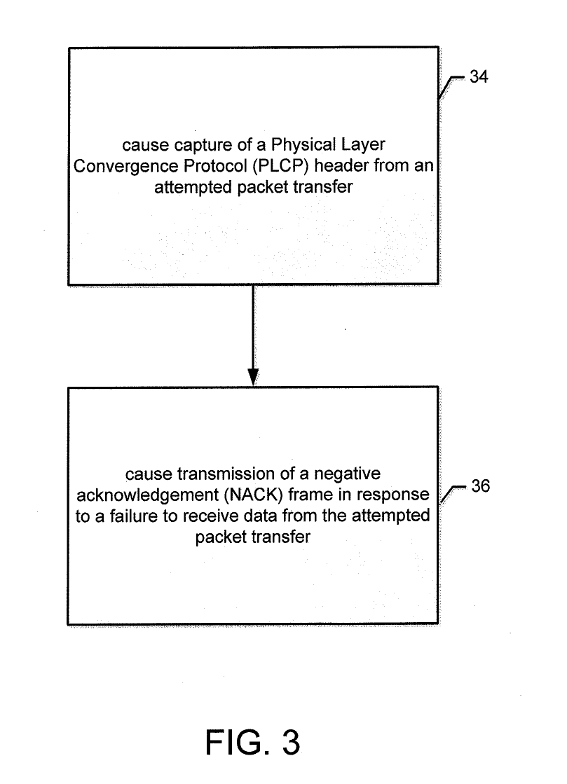

Referring now to FIG. 3, the operations performed by an apparatus 20, such as illustrated in FIG. 2, embodied by an access point 12 are illustrated and will be hereinafter described. Referring now to block 34 of FIG. 3, the apparatus may include means, such as the processing circuitry 22, the processor 24, the communication interface 28 or the like, for causing capture of a header from an attempted packet transfer from, for example, an AP 12, a STA 10 or the like. In one embodiment, the apparatus may include means for causing capture of a PHY header. In another embodiment, the apparatus may include means for causing capture of, for example, a Physical Layer Convergence Protocol (PLCP) header from an attempted packet transfer.

Referring now to block 36 of FIG. 3, the apparatus may include means, such as the processing circuitry 22, the processor 24, the communication interface 28 or the like, for causing transmission of a negative acknowledgement (NACK) frame in response to a failure to receive data from the attempted packet transfer.

In one embodiment, assuming that the transmitter address is captured, transmitting a NACK when a packet header is captured but the data is not received may help to distinguish an instance when collisions occur. For example, when a NACK or ACK are not sent, a transmitter may adapt more efficiently its back off window, MCS and/or other back off or EDCA parameters to combat congestion and hidden terminals more efficiently by concluding that a collision may have occurred (since the PHY header is transmitted with robust MCS the receiver may assume that the transmission has collided and it may choose e.g. not to adjust MCS). Furthermore, transmitting a NACK may further provide a mechanism that allows the retransmissions to be related to the original transmissions and further support HARQ schemes, in which the retransmission may be initiated faster and both the transmitter and the receiver may know how the retransmitted packets are related to the initial transmission. Such a mechanism enables diversity and combining gain for the retransmissions.

In one embodiment, two aspects if the NACK frame design may be considered, (1) physical layer (PHY) addressing information to support 802.11 NACK frame; and (2) the MAC layer information of the 802.11 NACK frame. By including a NACK frame to be a valid response in a WLAN, such as for example 802.11, an acknowledgement (ACK) frame may be utilized when a data transfer is successful and a NACK frame may be utilized when a header (e.g., PHY/PLCP header) is received and/or decoded correctly but the data portion fails. The failure may be due to a collision of data portions or the data portion may be received with a higher Modulation and Coding Scheme (MCS) than can be received correctly by a receiver at obtained signal-to-interference-plus-noise ratio (SINR) level during packet reception. In another embodiment, nothing may be sent (e.g., allowing a discontinuous transmission mode (DTX)) if both the PLCP and data portions fail. Such a situation may be interpreted as a collision, because without a collision, it may be assumed that PLCP may have been received correctly. A link adaptation algorithm may utilize such an instance to, for example, not adjust down the MCS.

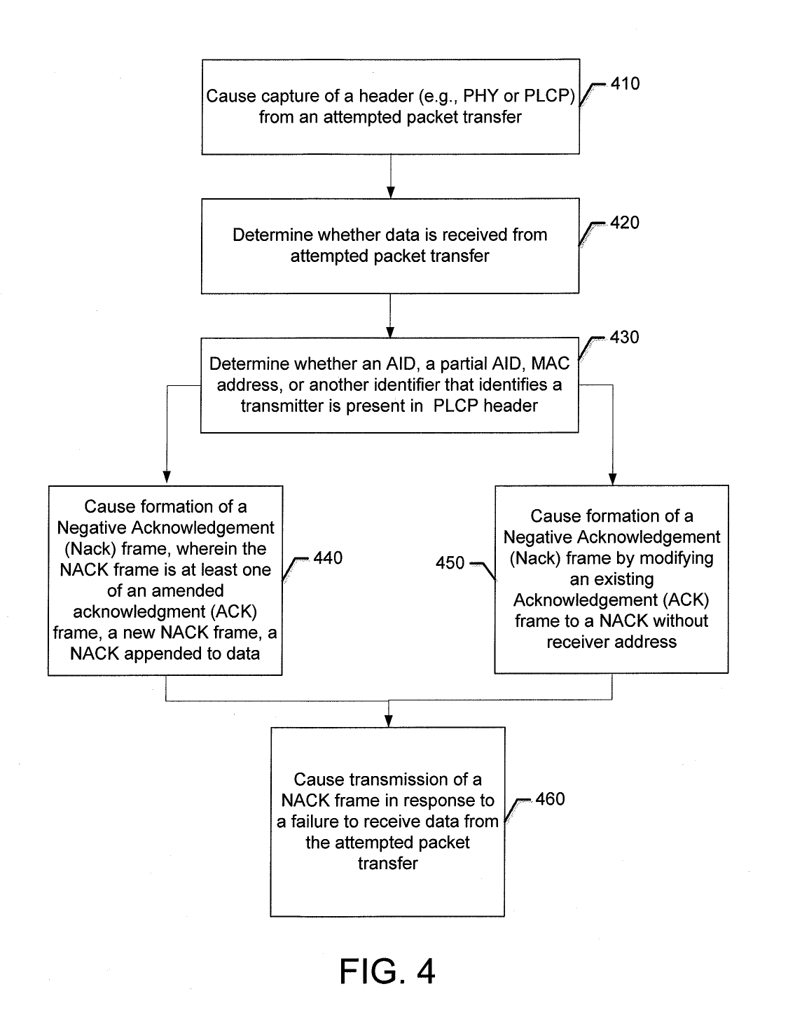

FIG. 4 illustrates a flow chart for operations performed by the apparatus 20, such as shown in FIG. 2, embodied by an access point 12 or station 10, in accordance with an example embodiment of the present invention. The operations performed by an apparatus 20, such as illustrated in FIG. 2, embodied by an access point 12 or station 10 are illustrated and will be hereinafter described. Referring now to block 410 of FIG. 4, the apparatus may include means, such as the processing circuitry 22, the processor 24, the communication interface 28 or the like, for causing capture of a header from an attempted packet transfer from, for example, an AP 12, a STA 10 or the like. In one embodiment, the apparatus may include means for causing capture of a Physical Layer Convergence Protocol (PLCP)/PHY header from an attempted packet transfer.

Referring now to block 420 of FIG. 4, the apparatus may include means, such as the processing circuitry 22, the processor 24, the communication interface 28 or the like, for determining whether data is received from the attempted packet transfer. If data is received, the apparatus may be configured to operate in accordance with current WLAN specification.

However, in an instance in which block 420 determines that reception or decoding of the data portion fails, the process proceeds to block 430. As shown in block 430 of FIG. 4, the apparatus may include means, such as the processing circuitry 22, the processor 24, the communication interface 28 or the like, for determining whether an identifier that identifies a transmitter (e.g., the association identifier (AID), partial association identifier (partial AID), MAC address, or any other identifier that identifies the transmitter in the Basic Service Set (BSS)) is present in the PLCP header information.

In an instance in which an identifier (e.g., an AID, partial AID, MAC address, or another identifier that identifies a transmitter) is present in the PLCP information, the process proceeds to block 440. As shown in block 440, of FIG. 4, the apparatus may include means, such as the processing circuitry 22, the processor 24, the communication interface 28 or the like, for cause formation of a NACK frame. In one embodiment, the NACK frame is at least one of an amended acknowledgment (ACK) frame, a new NACK frame, or a NACK appended to data.

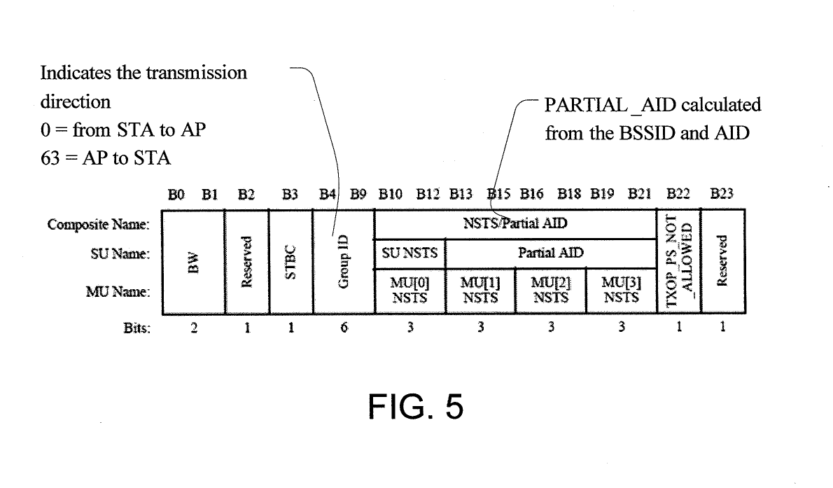

As discussed above, two aspects if the NACK frame design may be considered, (1) physical layer (PHY) addressing information to support 802.11 NACK frame; and (2) the MAC layer information of the 802.11 NACK frame. In one example embodiment, regarding physical layer address information to support 802.11 NACK frame, the 820.11 Very High Throughput (VHT) Physical Layer Convergence Protocol (PLCP) header includes a Partial Association Identification (Partial AID) and a GROUP ID in the SIG A1 field. Since the PLCP header may usually be transmitted with more robust Modulation and Coding Scheme (MCS), it is more likely that e.g., in the presence of interference, the PLCP header may be received correctly and the data part may fail. FIG. 5 shows an example illustration of a SIG A1 field. To support NACK frame transmissions, the SIG-A1 field is modified as follows.

When a station transmits a data frame to an access point, the PARTIAL_AID field may be calculated based on the same functions (e.g. by using STAs AID and BSSID as defined in 802.11-2012) as in the case where an access point transmits a frame to station. A GROUP_ID field may be set to zero. This requires no modifications to group ID field but requires calculation of an identifier, (e.g., the AID, partial AID, MAC address, or another identifier that identifies a transmitter) at the station side. In one embodiment, AP to STA and STA to AP directions may be separated in the group field (e.g., 0 for STA to AP transmission and 1 for AP to STA transmission). In an alternative embodiment, where different GROUP_ID values than 0 and 63 may be allowed, the GROUP_ID field may be set to be the identifier, (e.g., AID, partial AID, MAC address, or another identifier that identifies a transmitter) (calculated to be 6 bits) of the station and the PARTIAL_AID to be the Partial BSSID of the receiving access point.

When an access point responds with a NACK frame to a station, and if an access point receives the frame's PLCP header correctly but cannot decode the DATA part correctly, the access point checks the identifier (e.g., AID, partial AID, MAC address, or another identifier that identifies a transmitter) field of the SIG-A1 and may set the field to the same value that was in the DATA frame's PLCP. In an alternative embodiment, if an access point receives the frame's PLCP header correctly but cannot decode the DATA part correctly, the access point may check the GROUP_ID field of the SIG-A1 and then may set the identifier, (e.g., AID, partial AID, MAC address, or another identifier that identifies a transmitter) field to the value calculated from the GROUP ID of the PLCP frame and its own BSSID. In one embodiment, the AID used in calculating the identifier, (e.g., the AID, partial AID, MAC address, or another identifier that identifies a transmitter) may have only 6 bits. This identifier may then be used for the NACK frame's PLCP.

When an access point transmits a data frame to a station, the identifier, (e.g., AID, partial AID, MAC address, or another identifier that identifies a transmitter) field may be calculated based on the current functions as in the 802.12-2012. A GROUP_ID field may be set to 63 based on current specifications (indicating access point to station transmission). In an alternative embodiment, a GROUP_ID field may be set to be the identifier (calculated to be 6 bits) of the station and the identifier may be set to be the Partial BSSID of the transmitting access point.

When a station responds with a NACK frame to the access point, and if the station receives the frame's PLCP header correctly but cannot decode the DATA part, the station may check the identifier, (e.g., the AID, partial AID, MAC address, or another identifier that identifies a transmitter) of the SIG-A1 field and may set the field in the NACK PLCP header's SIG-A1 to the same value that was in the DATA frame's PLCP header. The GROUP ID may be set to (e.g., 0) to indicate the transmission direction. In an alternative embodiment, if the station receives the frames PLCP header correctly but cannot decode the data portion correctly, the station may check the GROUP ID to identify that the frame is intended for the station. The station may also check the identifier field of the SIG-A1 and may set the identifier field to the value taken from the DATA frame. The station may also set the GROUP_ID to be its own identifier. In one embodiment, the AID used in calculating the identifier may now have only 6 bits. This identifier may then be used for the NACK frame's PLCP/PHY header.

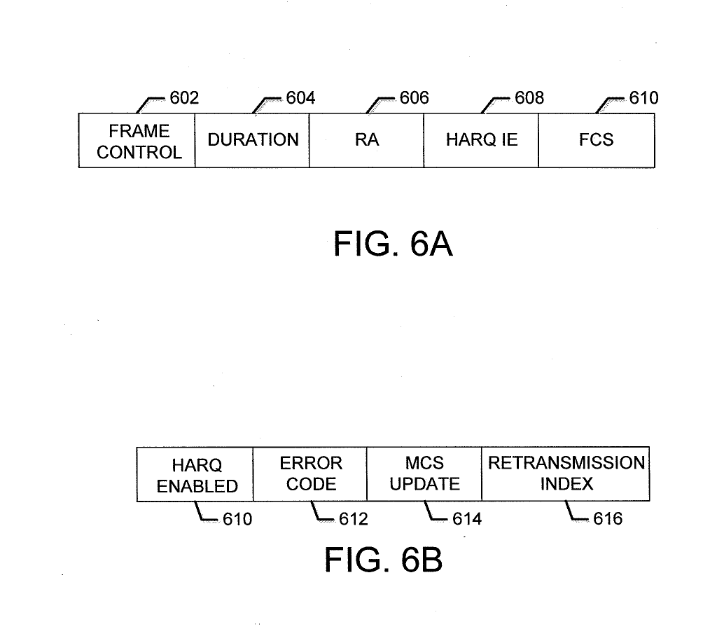

Turning now to the MAC layer information of the 802.11 NACK frame, FIG. 6A shows a NACK frame based on an ACK frame that supports HARQ. The NACK frame may include a frame control 602, duration 604, RA 606, HARQ information element (HARQ IE) 608, and frame check sequence (FCS) 610. In one embodiment, an RA Field, corresponding to the transmitter of the frame to be negatively acknowledged, may be removed from the MAC header and placed in the PHY where it may be protected by a separate FCS for better protection.

In one embodiment, in the Frame Control field, the reserved values may be used to signal that the new message type is a NACK (e.g., Type 11(reserved type) and subtype values 0000-1111 are reserved and Type 01 (control) and subtype values 0000-0110 are reserved). In another embodiment, retry and fragment bits may be used to indicate that the transmitted frame is a NACK. In one embodiment where, for example, multiple ways of sending a NACK frame type are allowed, the reserved values may also be used to indicate the type of NACK, e.g., if it is a NACK created from amending an ACK, a new NACK frame, a NACK piggybacked on data, or the like. In another embodiment, the reserved values may additionally or alternatively be used to indicate the type of NACK, e.g., NACK for HARQ operation or a NACK that indicates a packet failure but disabling HARQ retransmissions. A NACK that indicates a packet failure but disabling HARQ retransmissions may be used when, for example, if under the current channel conditions usage of HARQ is not beneficial.

FIG. 6B shows a HARQ Information Element (HARQ IE). HARQ IE may include HARQ enabled 610, Error Code 612, MCS UPDATE 614, and Retransmission index 616 as shown in FIG. 6B. HARQ Enabled 610 may include information regarding HARQ operation, such as for example, whether HARQ is enabled or not (in case it is not already indicated by a reserved frame control bit). Furthermore, in another embodiment, the HARQ IE may include one or more of a (1) No contention indication bit where for example, if set to 1, the current DCF mode is used and if set to 0, one of an amended DCF mode is introduced where the retransmission occurs immediately after the NACK (plus SIFS) or a TXOP mode is activated; (2) Contention parameters, which may be parameters for the retransmitted packet related to, for example, a back off window or other EDCA related parameter; (3) retransmission packet format, which may comprise an indication if chase combining is used or incremental redundancy. This may be 1 bit; (4) Capability change indication, which may be an indication of whether the receiver's capability has changed e.g., in terms of memory or the current number of HARQ processes may be going up or down. This may be 1 bit; and (5) Capability indication, which may indicate exact new parameters. This field may be present always or alternatively, only when the Capability change indication bit is set.

In one embodiment, an original packet may be re-transmitted. In another embodiment, a packet format indication defining incremental redundancy may indicate whether re-transmission should contain only original data bits, original parity bits obtained in channel coding process or a new set of parity bits obtained in a channel coding process but punctured away from the original transmission. A receiver may utilize different quality metrics to estimate quality of the received bits, and determinate an amount of information to be received in re-transmission, for example, the amount of needed new information. Therefore when quality of the already received bits from original transmission and/or a potential previous re-transmission is high, the receiver may reduce the number of bits to be retransmitted, e.g., reduce to the minimum amount possible or needed. This reduction of a number of bits to be re-transmitted may lead to a reduced time spent in retransmission, which may be utilized for other transmission in a system resulting in improved system capacity when compared to re-transmitting the original packet always and completely.

Error Code 612 may indicate a reason for transmission failure, such as for example, failure due to bad channel, or overlapping basic service set (OBSS). MCS Update 614 may indicate a change MCS request and/or suggestion for a specific MCS. A suggestion may depend on the margin by which transmission was not possible to be decoded.

The Duration field 604 of the NACK frame shown in FIG. 6A may include an amount of time for which the Network Allocation Vector (NAV) should be set for retransmissions. In one embodiment, the duration may depend on the HARQ transmission time and may be, for example, NAV(NACK)=SIFS+HARQ transmission time+SIFS+NACK transmission time. Alternatively, the HARQ transmission time may be estimated by the receiver based on the duration it took to send the original transmission and the proposed MCS. In one embodiment, the transmitter may not use a longer period to transmit its HARQ retransmission than what the HARQ transmission time indicates. In one embodiment, due to the design, the size of the NACK and the size of the ACK may be the same.

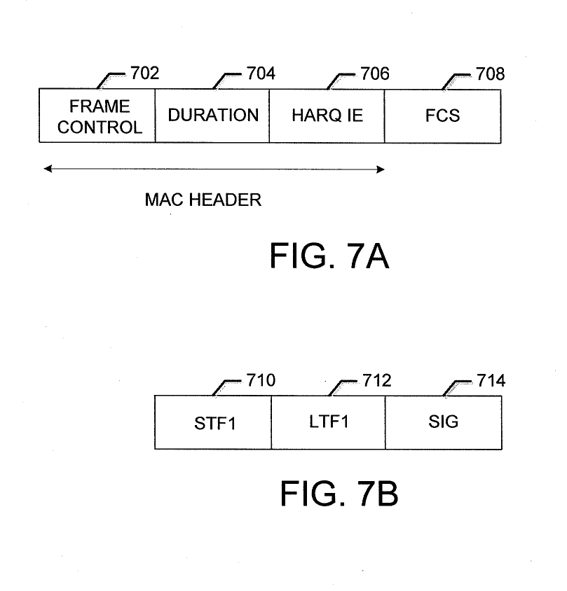

In another embodiment, a new NACK frame may be defined. A new NACK frame may provide a larger degree of freedom for the design than the option to use an existing ACK frame. FIG. 7A shows an example of a new NACK frame that supports HARQ. The new NACK frame may include frame control 702, Duration 704, HARQ IE 706, and FCS 708. As shown in FIG. 7A, frame control 702, HARQ IE 704 and duration 706 may be included in a MAC header. In one embodiment, an ACK frame and the NACK frame may be of different sizes. Having different sizes may help avoid problems of ACK and NACK confusion.

FIG. 7B shows an exemplary structure of a new NACK frame format including short training field (STF1) 710, long training field (LTF1) 712 and signal (SIG) 714. SIG 714 may include information (for example, all necessary information) from the Frame Control, Duration, RA and FCS of a normal ACK MAC frame (if NACK is based on the ACK design). Otherwise, SIG may include all information needed to negatively acknowledge a received frame. In one embodiment, MCS values may indicate a Short NACK. In an alternative embodiment, the frame control field, including a type and/or subtype field may indicate that the frame is a NACK frame. In one embodiment, duration may also be included in the SIG field. In another embodiment, an RA field may also be included. The Receiver Address (RA) field may be in terms of a MAC address, a partial AID, a partial BSSID or the like.

In another embodiment, a NACK may be appended to a data frame from the receiver. Appending the NACK frame to a data frame may improve channel access efficiency. In one embodiment, only the HARQ IE and a duration field may be appended in the data. The data packet may already have a frame control field and an FCS.

In one embodiment, the duration field may account for an ACK and a NACK not being of the same size. Additionally or alternatively, the duration may depend on the HARQ transmission time and may be, for example, NAV(NACK)=SIFS+HARQ transmission time+SIFS+max(ACK,NACK) transmission time. The max(,) accounts for the possibility that the ACK and NACK may be a different size.

It should be noted that, in an instance in which a transmitting entity receives a NACK in response, the transmitting entity may then retransmit the previously sent Physical Layer Service Data Unit (PSDU) in a same or modified format after waiting for Short Interframe Space (SIFS) time. If modified format is used, explicit or implicit signaling of the modifications may be required. In an instance in which a transmitting entity receives an ACK, the transmitting entity will set the contention window to its minimum value and may start contention again, as in the current WLAN 802.11 specification. In an instance in which the transmitting entity receives nothing in response, the transmitting entity adapts the contention window and starts the contention again, as in the current WLAN 802.11 specification.

Referring back to FIG. 4, in an instance in which the identifier, (e.g., the AID, partial AID, MAC address, or another identifier that identifies a transmitter in the BSS) is not present in the PLCP information, the process proceeds to block 450. As shown in block 450, of FIG. 4, the apparatus may include means, such as the processing circuitry 22, the processor 24, the communication interface 28 or the like, for causing formation of a NACK frame by modifying an existing ACK frame to a NACK without receiver address.

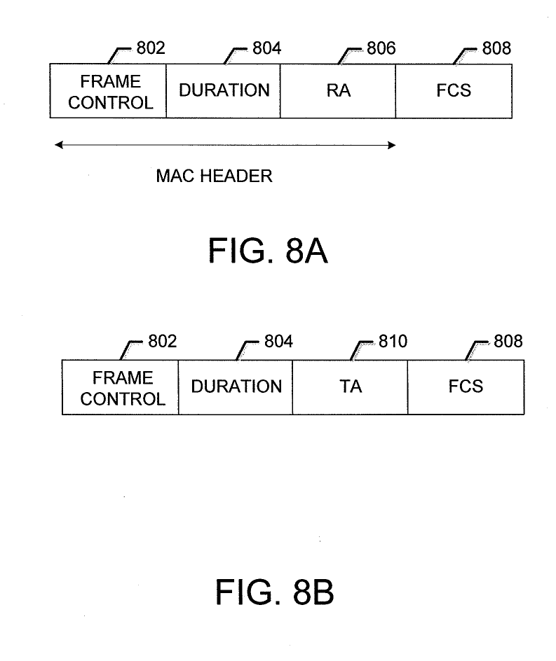

FIG. 8A shows an example of a current ACK MAC layer packet. The current ACK MAC layer packet may include a frame control 802, duration 804, RA 806, and a FCS 808. As shown in FIG. 8A, a MAC header may include frame control 802, duration 804, and RA 806. FIG. 8B shows an example implementation of a NACK frame with a TA address. The potential implementation may include frame control 802, duration 804, transmission address (TA) 810, and FCS 808. In one embodiment, an existing ACK frame may be utilized by reusing the available bits in the Frame Control field and by replacing the RA field. In an embodiment where a partial AID is not present in the PLCP header, the RA 806 for the ACK may not be known since the receiver of the data frame cannot decode the TA of the transmitted data. In such a case, the RA 806 may be replaced with the TA 810 of the NACK transmitter. Since a response frame (NACK or ACK) is transmitted after SIFS, the NACK may correspond to a correct transmission. In an instance in which the transmitter may not be known with high probability (e.g., in TXOP) such an approach may be used.

In one embodiment, an ACK frame may be modified to be a NACK frame by utilizing the frame control bits in a new and/or specific combination. Such use may enable the legacy devices to detect the frame as an ACK even though they are not able to decode the meaning of the Frame Control combination. Legacy devise may decode the duration field and set the NAV accordingly.

In one embodiment, the combination of for example, ‘RETRY’ and ‘FRAGMENT’ bits, may indicate that the message is a NACK. A legacy station may determine that this is a transmission of a fragmented packet and would then understand the non-zero duration field in a manner that another transmission will follow. In another embodiment, an ‘ORDER’ field may only be present in data frames, which may be used in an ACK message in combination with fragment to indicate the NACK.

As shown in block 460, of FIG. 4, the apparatus may include means, such as the processing circuitry 22, the processor 24, the communication interface 28 or the like, for causing transmission of a NACK frame in response to a failure to receive data from the attempted packet transfer.

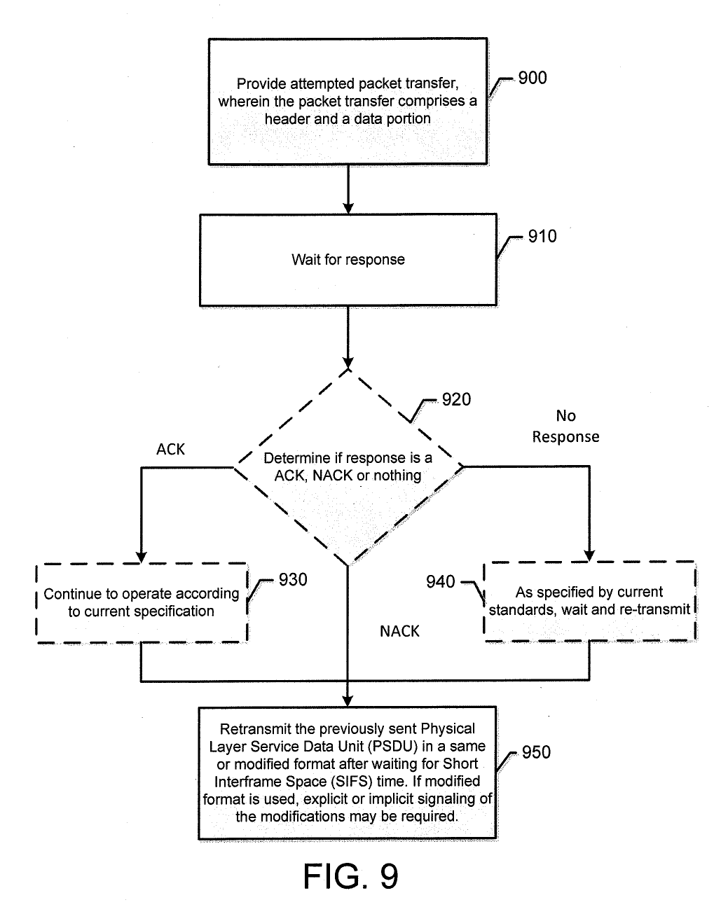

FIG. 9 illustrates a flow chart for operations performed by the apparatus 20, such as shown in FIG. 2, embodied by a station 10, in accordance with an example embodiment of the present invention. As shown in block 900 of FIG. 9, the apparatus embodied by a station may include means, such as the processing circuitry 22, the processor 24, the communications interface 28 or the like, for providing an attempted packet transfer, wherein the packet comprises a header portion and a data portion.

As shown in block 910 of FIG. 9, the apparatus embodied by the station may also include means, such as the processing circuitry, the processor or the like, for waiting for and/or receiving a response. As shown in block 920 of FIG. 9, the apparatus embodied by the station may also include means, such as the processing circuitry, the processor or the like, for determining whether a response is an ACK frame, a NACK frame or whether no response is received.

If the determination at block 920 is that the received response is an ACK frame, as shown in block 930, the apparatus embodied by the station may also include means, such as the processing circuitry, the processor or the like, for continuing to operate according to current WLAN specification. In an instance in which the determination at block 920 indicates that no response has been received, as shown in block 940, the apparatus embodied by the station may also include means, such as the processing circuitry, the processor or the like, for, as specified by current standards, continuing to wait and/or re-transmitting.

However, in an instance in which the determination at block 920 indicates that the received response is a NACK frame, as shown in block 950, the apparatus embodied by the station may also include means, such as the processing circuitry, the processor or the like, for,

As shown in block 940, the apparatus embodied by the station may also include means, such as the processing circuitry, the processor or the like, for retransmitting the previously sent PSDU in a same or modified format after waiting for SIFS time. In one embodiment, if a modified format is used, explicit or implicit signaling of the modifications may be required.

FIGS. 3, 4 and 9 illustrate example operations performed by a method, apparatus and computer program product, such as apparatus 20 of FIG. 2 as embodied by an access point 12 and a station 10, respectively, in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' blocks. As such, the operations of FIGS. 3, 4 and 9, when executed, convert a computer or processing circuitry into a particular machine configured to perform an example embodiment of the present invention. Accordingly, the operations of FIGS. 3, 4 and 9 define an algorithm for configuring a computer or processing circuitry 22, e.g., processor, to perform an example embodiment. In some cases, a general purpose computer may be provided with an instance of the processor which performs the algorithm of FIGS. 3, 4 and 9 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included as shown, for example, by the blocks having a dashed outline in FIG. 10. It should be appreciated that each of the modifications, optional additions or amplifications below may be included with the operations above either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for use in an access point or station comprising:
causing capture of a header from an attempted packet transfer; and
causing transmission of a negative acknowledgement (NACK) frame in response to a transmitter comprising the decoded address in the header, the NACK configured to indicate a failure to receive or decode data from the attempted packet transfer.

2. The method of claim 1, wherein the NACK frame is at least one of an amended acknowledgment (ACK) frame, a new NACK frame, a NACK appended to data.

3. The method of claim 2, wherein, in an instance in which the header includes a transmitter address, an amended ACK frame is formed by:
modifying a first field, which comprises a Group ID field and a Partial AID field, by setting the Partial association identifier (AID) field to a value calculated from a Group ID field of the captured header and its own Basic Service Set Identifier (BSSID).

4. The method of claim 2, wherein, in an instance in which the header includes a transmitter address, an amended ACK frame is formed by:
modifying a first field, which comprises a Group ID field and a Partial AID field, by setting the Partial AID field to a value of the partial AID of the captured header and setting the Group ID field to its own partial ID.

5. The method of claim 2, wherein, in an instance in which the header includes a transmitter address, a new NACK frame is formed by: moving MAC layer information to a PHY layer and causing formation of a SIG filed comprising information from a frame control field, a duration field, a receiver address (RA) field and a frame check sequence (FCS) field of an ACK frame.

6. The method of claim 2, wherein, in an instance in which the header does not include a transmitter address, an amended ACK frame is formed by:
utilizing a specific combination of frame control bits; and modifying an existing ACK frame by replacing a receiver address (RA) field with a transmitter address of a transmitting device.

7. The method according to claim 1, wherein the header is a Physical Layer Convergence Protocol (PLCP) header.

8. A method for use in an access point or station comprising:
providing an attempted packet transfer, wherein the packet comprises a header portion and a data portion; and
providing retransmission of previously sent data portion in a same or modified format after receiving a negative acknowledgement (NACK) frame in response to the attempted packet transfer, the NACK configured to indicate a failure to receive or decode data from the attempted packet transfer.

9. The method according to claim 8, wherein retransmission of previously sent data portion is provided in a modified format; and wherein the method further comprises providing explicit or implicit signaling of one or more modifications.

10. An apparatus comprising at least one processor and at least one memory including computer program code, the at least one memory and the computer program code configured to, with the processor, cause the apparatus to at least:
cause capture of a header from an attempted packet transfer;
cause transmission of a negative acknowledgement (NACK) frame in response to a transmitter comprising the decoded address in the header, the NACK configured to indicate a failure to receive or decode data from the attempted packet transfer.

11. The apparatus of claim 10, wherein the NACK frame is at least one of an amended acknowledgment (ACK) frame, a new NACK frame, a NACK appended to data.

12. The apparatus of claim 11, wherein, in an instance in which the header includes a transmitter address, an amended ACK frame is formed by:
modifying a first field, which comprises a Group ID field and a Partial AID field, by setting the Partial AID field to a value calculated from a Group ID field of the captured header and its own BSSID.

13. The apparatus of claim 11, wherein, in an instance in which the header includes a transmitter address, an amended ACK frame is formed by:
modifying a first field, which comprises a Group ID field and a Partial AID field, by setting the Partial AID field to a value of the partial AID of the captured header and setting the Group ID field to its own partial ID.

14. The apparatus of claim 11, wherein, in an instance in which the header includes a transmitter address, a new NACK frame is formed by: moving MAC layer information to a PHY layer and causing formation of a SIG filed comprising information from a frame control field, a duration field, a receiver address (RA) field and a frame check sequence (FCS) field of an ACK frame.

15. The apparatus of claim 11, wherein, in an instance in which the header does not include a transmitter address, an amended ACK frame is formed by:
utilizing a specific combination of frame control bits; and modifying an existing ACK frame by replacing a receiver address (RA) field with a transmitter address of a transmitting device.

16. The apparatus according to claim 10, wherein the header is a Physical Layer Convergence Protocol (PLCP) header.

17. An apparatus comprising at least one processor and at least one memory including computer program code, the at least one memory and the computer program code configured to, with the processor, cause the apparatus to at least:
provide an attempted packet transfer, wherein the packet comprises a header portion and a data portion; and
provide retransmission of previously sent data portion in a same or modified format after receiving a negative acknowledgement (NACK) frame in response to the attempted packet transfer, the NACK configured to indicate a failure to receive or decode data from the attempted packet transfer.

18. The apparatus according to claim 17, wherein retransmission of previously sent data portion is provided in a modified format; and wherein the at least one memory and the computer program code are further configured to, with the processor, cause the apparatus to provide explicit or implicit signaling of one or more modifications.
